(19) United States
(12) Patent Application Publication
(10) Pub. No.: US 2004/0207867 A1
(43) Pub. Date: Oct. 21, 2004

(54) System for and method of distributing mail

(76) Inventor: Gary Glen Stringham, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/418,542

(22) Filed: Apr. 17, 2003

(51) Int. Cl. G06F 15/00

(52) U.S. Cl. 358/1.15

(57) ABSTRACT

A method of distributing mail, comprises electronically transmitting a first print job and a first list of postal addresses of multiple recipients to which the print job is desired to be delivered from a first user's location; routing the first print job to respective postal facilities separate from the first user's location, the postal facilities being selected based on the postal addresses; and at a postal facility, printing out print jobs for respective addressees in an order corresponding to a postal facility delivery route. A system for distributing mail is also provided.

### FIELD OF THE INVENTION

The invention relates to sorting and delivery of mail. The invention relates to electronic mail and paper mail.

### BACKGROUND OF THE INVENTION

Various systems and methods have been proposed for integrating e-mail with postal service regular mail.

An article entitled “How the Postman Almost Owned E-Mail” by Stuart Brotman, Technology Review, Jul. 29, 2002 discusses how the U.S. Postal Service was contemplating a system in January 1982 called E-COM, Electronic Computer-Originated Mail. The article states that E-COM was a message system designed to serve volume mailers, such as Shell Oil and Merrill Lynch, by generating mail from data stored electronically. The service rolled out to 25 post offices and transmitted messages to other cities, which then transformed them into hard copy and delivered them within two days.

An article entitled “Post Office Sees Big Online Opportunity” by Mary Hillebrand, E-Commerce Times, May 27, 1999 discloses a more recent USPS scheme, apparently for use by volume mailers. This article states that with this system, “Mailing Online,” users create a document on their own computer, e-mail the document and their mailing lists to the post office, and pay the post office to print, stuff, and mail the document. The article also mentions similar programs run by Canada Post and France's La Poste.

An article entitled “Postal Service to deliver the e-mail” by Julia Angwin, Wall Street Journal Online, Jul. 30, 2000 discloses Postal Service e-mail accounts and contemplates that a teaser marketing message could come by e-mail followed by a more detailed ad or catalog through paper mail. The article also discusses how, in Britain, the Royal Mail and Microsoft Corp. recently launched a service called Relayone. Postal services in Finland and Switzerland are also planning to print e-mail messages and deliver them.

A Microsoft “PressPass” press release dated May 7, 2001 discusses the ability to create correspondence with customers using “bCentral” services and then transfer that document electronically to the post office for printing and mailing.

A press release by Royal Mail describes the “Relayone” system in greater detail. The article states, on page 2, that Using Relayone, documents and telegrams sent from anywhere in the world are received at Royal Mail's Electronic Services Center in London, where they are first printed, put in a distinctive envelope and dispatched by First Class mail. The Relayone system uses a central location from which regular mail is sent.

A problem to be solved is the need for a system and method that allows users to send an e-mail or electronically transmitted print job and have letters printed out and efficiently sorted.

### SUMMARY OF THE INVENTION

One aspect of the invention provides a method of distributing mail, comprising electronically transmitting a first print job and a first list of postal addresses of multiple recipients to which the print job is desired to be delivered from a first user's location; routing the first print job to respective postal facilities separate from the first user's location, the postal facilities being selected based on the postal addresses; and at a postal facility, printing out print jobs for respective addressees in an order corresponding to a postal facility delivery route.

Another aspect of the invention provides a method of distributing mail, comprising electronically transmitting a print job and a list of addresses of multiple recipients to which the print job is desired to be delivered from a user's location to a server, the print job being mergable with respective addresses of the list to define multiple separate individually addressed electronic mail pieces; merging the print job with respective addresses of the list to define multiple separate individually addressed electronic mail pieces; electronically routing the individually addressed electronic mail pieces from the server to respective distribution centers separate from the first user's location, the distribution centers being selected based on proximity to the addresses of the individually addressed pieces; and at each distribution center for which an individually addressed electronic mail piece has been received, printing out mail pieces for respective addressees in an order corresponding to a predetermined delivery route.

Another aspect of the invention provides a system for distributing mail, comprising a plurality of printers, the printers being located in different geographic locations; a server configured to receive, from a client machine, an electronically transmitted print job and a list of addresses of multiple recipients to which the print job is desired to be delivered, the server being configured to electronically route the print job via a network to selected printers, the server being configured to select printers based on proximity of the printers to the addresses of the individually addressed pieces, the server being configured to cause each selected printer to print out mail pieces for respective addressees in an order corresponding to a predetermined delivery route.

Another aspect of the invention provides a system for distributing mail, comprising a plurality of printers, the printers being located in different geographic locations; a plurality of computers located in at least some of the different geographic locations, coupled to respective ones of the printers; and a server configured to receive, from a client machine, an electronically transmitted print job and a list of addresses of multiple recipients to which the print job is desired to be delivered, the server being configured to electronically route the print job and at least portions of the list of addresses via a network to selected ones of the computers, the server selecting computers based on proximity of the respective coupled computers and printers to the addresses of the recipients, the selected computers being configured to merge the print job with respective addresses of the list to define multiple separate individually addressed electronic mail pieces, the selected computers being configured to cause the printer coupled to the selected computer to print out mail pieces for respective addressees in an order corresponding to a predetermined delivery route.

Still another aspect of the invention provides a system for distributing mail, comprising means for electronically transmitting a print job and a list of addresses of multiple recipients to which the print job is desired to be delivered from a user's location to a server, the print job being mergable with respective addresses of the list to define multiple separate individually addressed electronic mail pieces; means for merging the print job with respective addresses of the list to define multiple separate individually addressed electronic mail pieces; means for electronically routing the individually addressed electronic mail pieces from the server to respective distribution centers separate from the first user's location, the distribution centers being selected based on proximity to the addresses of the individually addressed pieces; and at each distribution center for which an individually addressed electronic mail piece has been received, means for printing out mail pieces for respective addressees in an order corresponding to a predetermined delivery route.

These and other aspects of the present invention will be discussed in greater detail hereinafter.

### DESCRIPTION OF THE DRAWINGS

FIG. 1 is a block diagram of a system for distributing mail in accordance with various embodiments.

FIG. 2 is a block diagram of an alternative system for distributing mail in accordance with various embodiments.

FIG. 3 is a flowchart of a method of distributing mail in accordance with various embodiments.

### DETAILED DESCRIPTION OF THE INVENTION

This disclosure of the invention is submitted in furtherance to the constitutional purposes of the U.S. Patent Laws to promote the progress of science and the useful arts.

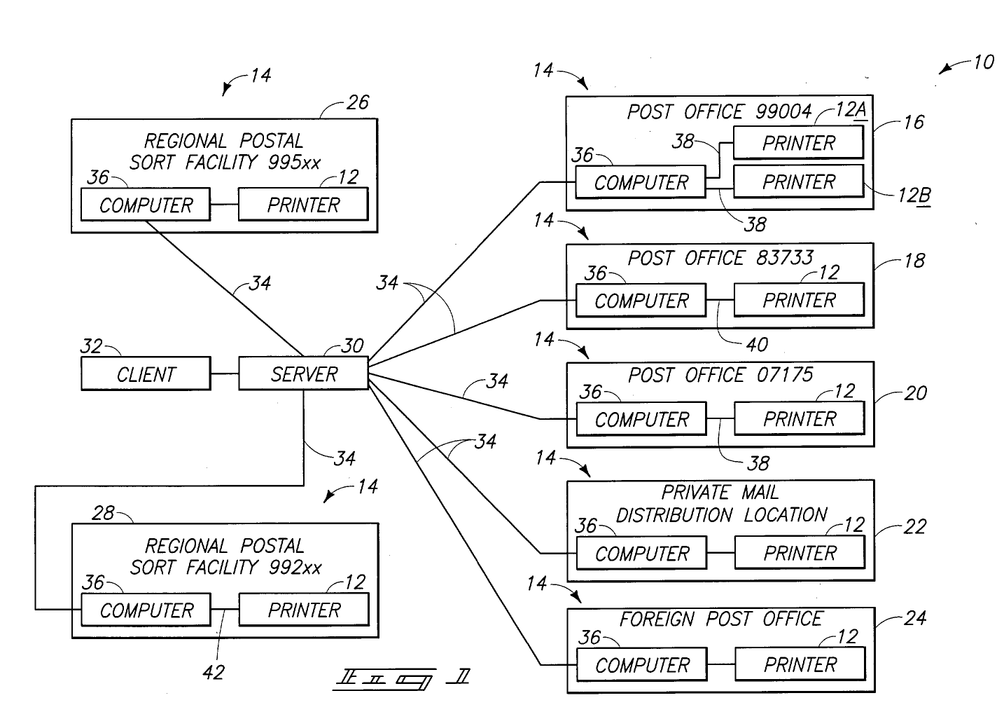

FIG. 1 shows a system 10 for distributing mail. The system 10 includes a plurality of printers 12. The printers 12 can include low-end to high-end monochrome printers, color printers, or digital press printers. The printers 12 are located in different geographic locations. More particularly, in the illustrated embodiment, the printers 12 are located in postal facilities 14 such as U.S. Postal Service post offices 16, 18, 20, private mail distribution locations 22 (e.g., Mailboxes Etc.™), post offices of other countries 24, regional postal sorting centers 26, 28, or combinations thereof. The postal facilities 14 are located in different geographic areas such as different cities, different areas of cities, different zip codes, and/or different countries. In some facilities (see, for example, facility 16), multiple printers (see, e.g., 12A and 12B) can be included and the list of addresses can be appropriately shared—for example, assuming two printers in a given facility 14, one printer handles A-M and the other printer handles N-Z; one printer handles one part of town, another printer handles another part of town; one printer handles color, another printer handles black and white; one printer handles folded paper, another handles postcards or flyers, etc.

The system 10 includes a server 30 configured to receive, from a client machine 32 (a user's computer or terminal), an electronically transmitted print job and a list of addresses of multiple recipients to which the print job is desired to be delivered. The server 30, in operation, electronically routes the print job and at least portions of the list of addresses via a network 34 to selected ones of the printers 12. The network 34 includes or makes use of a postal service network (e.g., a WAN), the Internet, satellite or RF links, or land lines.

The server 30, in operation, selects printers 12 or postal facilities 14 based on proximity of the printers 12 or postal facilities 14 to the addresses of the recipients.

In some embodiments, the system 10 further comprises computers 36 located in at least some of the different geographic locations in which the printers 12 are located. The computers 36 are coupled with the respective printers 12. The server 30 communicates with the printers 12 via the computers 36. The computers 36, if included, in operation merge the print job with respective addresses of the list to define multiple separate individually addressed electronic files or electronic mail pieces. The computer 36 in each postal facility 14 is configured to cause the printer 12 or printers 12A and 12B in that facility to print out the electronic mail pieces for respective addressees in an order corresponding to a predetermined delivery route, such as a carrier sort route, a rural route, or a regional truck route. This saves substantial effort for the postal facility 14. In one or more of the geographic locations, a local area network 38 is provided to couple one or more printers 12 to a computer 36. Alternatively, in one or more of the geographic locations, printers 12 are directly coupled to the computers 36 (e.g., using a parallel port 40 or wireless link 42), instead of via a local area network 38.

In alternative embodiments, the server 30 performs the merging and the sorting. In these embodiments, the server 30 merges the print job with respective addresses of the list to define multiple separate individually addressed electronic mail pieces.

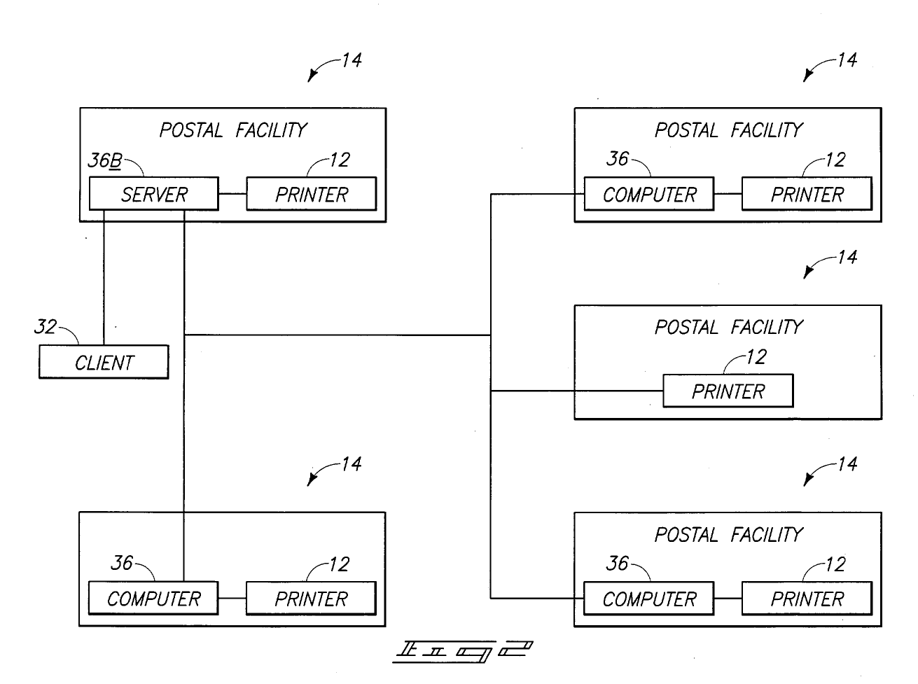

In one alternative embodiment, shown in FIG. 2, a client machine 32 communicates with a computer 36B in one of the postal facilities 14 or geographic locations, and that computer 36B communicates with printers 12 in other postal facilities or geographic locations, either directly or via other computers 36. The computer 36B communicates with the other computers 36 or printers 12 using WANs, LANs, and/or the Internet.

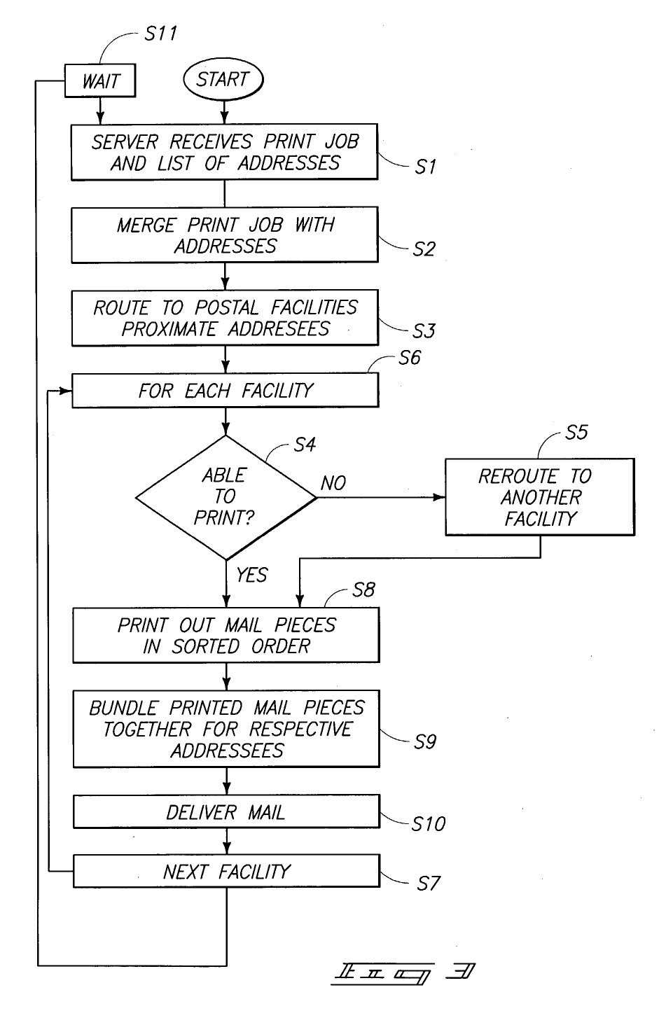

FIG. 3 illustrates a method in accordance with various embodiments. In step S1, a user electronically transmits a print job and a list of addresses of multiple recipients to which the print job is desired to be delivered from a user's location 32 to the server 30. The print job is mergable with the addresses of the list to define multiple separate individually addressed electronic mail pieces.

In step S2, the print job is merged with respective addresses of the list to define multiple separate individually addressed electronic mail pieces. In some embodiments, the merging is performed by the server 30. In other embodiments, the merging is performed by one or more of the computers 36.

In step S3, the individually addressed electronic mail pieces are electronically routed from the server 30 to respective distribution centers 14 separate from the user's location. In some embodiments, the server 30 selects the distribution centers 14 based on the proximity of the distribution centers to the addresses of the individually addressed pieces. In some embodiments, the distribution centers may be postal facilities described above. From the sender's perspective, this is distributed printing. The sender's mail is being printed on printers 12 near each recipient. In some embodiments, the merging takes place before the routing—in other embodiments, the routing takes place before the merging.

In step S8, at distribution centers 14 for which an individually addressed electronic mail piece has been received, mail pieces are printed out for respective addressees in an order corresponding to a predetermined delivery route, such as a carrier sort route, P.O. box numeric order, truck route, rural route, intercity route, etc. For P.O. Boxes, the printer still prints the mail pieces in order, making it easier for the postal worker to quickly put the mail pieces in the boxes. Thus, the entire front end sorting of conventional mail is bypassed. Sorting instead is performed by computer. In some embodiments, at one or more of the distribution centers 14, multiple mail pieces for a given addressee are printed together. Therefore, all printed mail for a given household, whether it is addressed to the man of the house, the woman of the house, to a kid, to Postal Patron or Current Resident, is together in the pile. In other words, machinery does the sorting of the mail for the Post Office, not a postal worker.

In some embodiments, the mail pieces are printed at night or outside normal business hours. As illustrated by step S11, in some embodiments, one printing occurs at some regular interval, each night, or from time to time, and print jobs received from users after a printing has been completed are saved until the next time for printing (e.g., the next night).

Because confidential information may be being printed, the printed pieces of mail for each recipient are bundled or secured, in some embodiments, in step S9. In certain embodiments, mail pieces for each addressee are bundled together and covered such that the address of the addressee is visible. More particularly, mail pieces for each addressee are bundled together such that content of the mail pieces, other than the address of the addressee, is not visible. Using standard paper handling device, the pile of mail for each recipient can all be put into one envelope or shrink-wrapped with the recipients' address visible. In some embodiments, the shrink-wrap is clear, but a non-confidential piece of mail or sheet (e.g., an advertisement) is placed on the top and/or bottom of the pile. In other embodiments, plastic envelopes are used having a clear area as a window for the address and the rest of it obscured, hiding the rest of the top sheet. This bundling is advantageous in that the postal carrier can easily pick up the whole bundle of printed pieces of mail for one recipient, rather than leafing through the pile to find where the mail for one recipient ends and the mail for the next one begins. Because of the way most mailboxes are, in some embodiments, the pile or individual pieces for an addressee are folded before being stuffed in an envelope or shrink-wrapped.

In some embodiments, for at least some addressees, in step S9 mail pieces for that addressee are bundled together in a plastic envelope having a clear area defining a window though which an address can be seen, and the rest of the envelope obscures the contents of the envelope.

In certain embodiments, printed mail pieces for each addressee are shrink-wrapped together.

In certain embodiments, if all printers at one of the geographic locations or facilities are not able to print, a mail piece for an addressee is printed at a nearby geographic location or facility. In these embodiments, in step S4, a determination is made as to whether printing is possible at a geographic location or facility. If so, the printing takes place at that location or facility at step S8. If not, printing takes place at a nearby facility in a revised order corresponding to the delivery routes at a new location. More particularly, the print job is rerouted in step S5. This test is performed for each facility or printer using looping logic in step S6 and S7.

Alternatively, the original order can be maintained and the printed pieces printed at the alternate facility can be transferred to the proper facility for delivery. Because there are many post offices in each country, if the printer in one post office goes down, the jobs can be sent to a neighboring postal faciliity for printing and bundling and then transported back to the one office for delivery.

In step S10, the printed mail is delivered. In some embodiments, the operator walks up to the printer, pulls out the stack of mail for a given route, and puts it on the delivery vehicle or pouch for that route. As the postal carrier drives or walks around the route, all the mail for the next house is always on top of the stack. The postal carrier takes the sheets or bundles of mail for that house and simply puts it in the mailbox.

Mail can be sent very quickly this way. A sender may be on the East Coast and a recipient on the West Coast. The print job is routed to the appropriate city in the West Coast, where it is printed and delivered. The recipient receives the mail promptly; e.g., the next day, even though it was mailed on the other side of the country. The Post Office is saved from having to actually haul a paper letter across the country using trucks and planes, and saved from the handling of the mail at each junction along the way.

There are many different types of senders that could advantageously use the systems or methods disclosed herein. Advertisers currently spend lots of money at commercial print houses to print up bulk mail. Using applicant's embodiments, they can let the Post Office distribute it. Also, there is no inventory of old bulk mail because the Post Office will only print off as many as will be delivered. Banks can send out monthly statements or loan papers using applicant's embodiments. The loan papers would be reviewed, signed, and then mailed back. Credit card companies, utilities, insurance companies, and other business can send their statements and bills using applicant's system or method. Employers can mail pay stubs to employees. Churches, clubs, civic groups, etc. can send out notices and fliers to their members. A sports team parent can send out an updated game schedule to multiple parents. Neighborhood associations can send out news, dues notices, prowler warnings, etc., to everybody in the subdivision by giving a database with wild-card addresses, such as 110 through 240 on Chinden Boulevard, 110 through 240 on Barley Street, etc. Families can send out reunion notices or newsletters. Political candidates can send out fliers to constituents in their district. Real estate agents can send out information about a new house to their clients who are currently looking using this system.

In certain embodiments, subscribers of periodicals (newspapers, magazines) that are delivered through the Post Office can log on to the periodical's web page and specify their home address and which sections are wanted, and for each issue (nightly, weekly, monthly, etc.) the periodical sends the sections that the user wants using this system. Newspaper subscribers can set up customized classifieds (e.g. trucks, pets, or houses) to be sent every day using this system.

The United States Post Office's web site allows people to send mail online (Mail Online, MOL.) MOL also provides a mail merge function. The resulting mail can use applicant's system or method to deliver this mail rather than putting it in separate envelopes, stamping, and dropping it in the regular mail system.

The military can use applicant's system or method to rapidly deliver mail to soldiers, no matter where they are around the world. In certain embodiments, the Post Office for a military unit contains a portable computer and printer, which the military can move and set up wherever they want and get the day's mail for everybody in the unit.

An advantage of applicant's system and method is that cost and time for the senders are reduced in that no folding of paper, no stuffing of envelopes, no addressing of envelopes, and no licking of stamps by senders is necessary. Also, the cost, time, and handling by the Post Office of these mail items are reduced. In certain embodiments, mail for a recipient is sent in one envelope, rather than each mail with its own envelope, thereby reducing weight that the Post Office has to haul. If a recipient is only going to have one sheet that day, and if it only contains non-confidential mail (e.g., bulk mail), the sheet is not put in an envelope, in certain embodiments, thereby saving costs to the Post Office.

An advantage is that recipients are not required to have email, an Internet connection, or even a computer.

In compliance with the patent statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method of distributing mail, comprising:
electronically transmitting a first print job and a first list of postal addresses of multiple recipients to which the print job is desired to be delivered from a first user's location;
routing the first print job to respective postal facilities separate from the first user's location, the postal facilities being selected based on the postal addresses; and
at a postal facility, printing out print jobs for respective addressees in an order corresponding to a postal facility delivery route.

2. A method of distributing mail in accordance with claim 1 and further comprising electronically transmitting a second print job and a second list of postal addresses of multiple recipients to which the print job is desired to be delivered from a second user's location, and routing the second print job to respective postal facilities separate from the second user's location, the postal facilities being selected based on the postal addresses of the second list, wherein at postal facilities for which both the first mentioned and second print jobs have been received, print jobs for recipients receiving both the first and second print jobs are grouped together.

3. A method of distributing mail in accordance with claim 1 wherein, at one of the postal facilities, multiple print jobs for a given addressee are printed together.

4. A method of distributing mail in accordance with claim 1 wherein, at one of the postal facilities, multiple print jobs for addressees having post office box numbers are printed in an order selected based on the post office box numbers.

5. A method of distributing mail in accordance with claim 1 wherein print jobs are printed at night for at least one of the postal facilities.

6. A method of distributing mail in accordance with claim 1 wherein the print job defines bulk mail.

7. A method of distributing mail in accordance with claim 1 wherein electronically transmitting the print job comprises transmitting the print job via the Internet.

8. A method of distributing mail in accordance with claim 1 and further comprising electronically mail-merging respective addresses from the list with the print job.

9. A method of distributing mail in accordance with claim 1 wherein, at each postal facility, print jobs for each addressee are bundled together and covered such that the address of the addressee is visible.

10. A method of distributing mail in accordance with claim 1 wherein, at each postal facility, print jobs for each addressee are bundled together such that content of the mail pieces, other than the address of the addressee, is not visible.

11. A method of distributing mail in accordance with claim 1 wherein, at each postal facility, print jobs for each addressee are shrink wrapped together.

12. A method of distributing mail in accordance with claim 1 wherein, at each postal facility, print jobs for each addressee are bundled together in a plastic envelope having a clear area defining a window though which an address can be seen and the rest of the envelope obscuring the contents of the envelope.

13. A method of distributing mail in accordance with claim 1 wherein, if a printer at one of the postal facilities at which a print job for an addressee would have been printed is not able to print, the print job for an addressee is instead printed at a nearby postal facility.

14. A method of distributing mail, comprising:
electronically transmitting a print job and a list of addresses of multiple recipients to which the print job is desired to be delivered from a user's location to a server, the print job being mergable with respective addresses of the list to define multiple separate individually addressed electronic mail pieces;
merging the print job with respective addresses of the list to define multiple separate individually addressed electronic mail pieces;
electronically routing the individually addressed electronic mail pieces from the server to respective distribution centers separate from the first user's location, the distribution centers being selected based on proximity to the addresses of the individually addressed pieces; and
at each distribution center for which an individually addressed electronic mail piece has been received, printing out mail pieces for respective addressees in an order corresponding to a predetermined delivery route.

15. A method of distributing mail in accordance with claim 14 wherein, at one of the distribution centers, multiple mail pieces for a given addressee are printed together.

16. A method of distributing mail in accordance with claim 14 wherein, at one of the distribution centers, multiple mail pieces for addressees having post office box numbers are printed in an order selected based on the post office box numbers.

17. A method of distributing mail in accordance with claim 14 wherein the mail pieces are printed at night.

18. A method of distributing mail in accordance with claim 14 wherein the mail pieces are printed outside normal business hours of the respective distribution centers.

19. A method of distributing mail in accordance with claim 14 wherein the print job defines bulk mail.

20. A method of distributing mail in accordance with claim 14 wherein electronically transmitting a first print job comprises transmitting the first print job via the Internet.

21. A method of distributing mail in accordance with claim 14 wherein, at each distribution center, mail pieces for each addressee are bundled together and covered such that the address of the addressee is visible.

22. A method of distributing mail in accordance with claim 14 wherein, at each distribution center, mail pieces for each addressee are bundled together such that content of the mail pieces, other than the address of the addressee, is not visible.

24. A method of distributing mail in accordance with claim 14 wherein, at each distribution center, mail pieces for each addressee are shrink wrapped together.

25. A method of distributing mail in accordance with claim 14 wherein, at each distribution center, mail pieces for each addressee are bundled together in a plastic envelope having a clear area defining a window though which an address can be seen and the rest of the envelope obscuring the contents of the envelope.

26. A method of distributing mail in accordance with claim 14 wherein, if all printers at one of the distribution centers are not able to print, a mail piece for an addressee is printed at a nearby distribution center.

27. A system for distributing mail, comprising:
a plurality of printers, the printers being located in different geographic locations;
a server configured to receive, from a client machine, an electronically transmitted print job and a list of addresses of multiple recipients to which the print job is desired to be delivered, the server being configured to electronically route the print job via a network to selected printers, the server being configured to select printers based on proximity of the printers to the addresses of the individually addressed pieces, the server being configured to cause each selected printer to print out mail pieces for respective addressees in an order corresponding to a predetermined delivery route.

28. A system in accordance with claim 27 and further comprising computers located in at least some of the different geographic locations in which the printers are located and coupled with the respective printers, wherein the server communicates with the printers via the computers.

29. A system in accordance with claim 28 wherein the server is configured to merge the print job with respective addresses of the list to define multiple separate individually addressed electronic mail pieces.

30. A system in accordance with claim 28 and comprising at least one local area network coupling a computer to a printer in one of the geographic locations.

31. A system in accordance with claim 30 wherein the server is configured to communicate with at least some of the computers via the Internet and wherein some of the printers are coupled to the respective computers via respective local area networks.

32. A system in accordance with claim 30 wherein the server is configured to communicate with at least some of the computers via the Internet and wherein at least some of the printers are directly attached to the respective computers and others of the printers are coupled to respective computers via respective local area networks.

33. A system for distributing mail, comprising:
a plurality of printers, the printers being located in different geographic locations;
a plurality of computers located in at least some of the different geographic locations, coupled to respective ones of the printers; and
a server configured to receive, from a client machine, an electronically transmitted print job and a list of addresses of multiple recipients to which the print job is desired to be delivered, the server being configured to electronically route the print job and at least portions of the list of addresses via a network to selected ones of the computers, the server selecting computers based on proximity of the respective coupled computers and printers to the addresses of the recipients, the selected computers being configured to merge the print job with respective addresses of the list to define multiple separate individually addressed electronic mail pieces, the selected computers being configured to cause the printer coupled to the selected computer to print out mail pieces for respective addressees in an order corresponding to a predetermined delivery route.

34. A system in accordance with claim 33 wherein the server is configured to receive the print job from the client machine via e-mail.

35. A system in accordance with claim 33 wherein the server is configured to receive the print job from the client machine via a web interface.

36. A system for distributing mail, comprising:
means for electronically transmitting a print job and a list of addresses of multiple recipients to which the print job is desired to be delivered from a user's location to a server, the print job being mergable with respective addresses of the list to define multiple separate individually addressed electronic mail pieces;
means for merging the print job with respective addresses of the list to define multiple separate individually addressed electronic mail pieces;
means for electronically routing the individually addressed electronic mail pieces from the server to respective distribution centers separate from the first user's location, the distribution centers being selected based on proximity to the addresses of the individually addressed pieces; and
at each distribution center for which an individually addressed electronic mail piece has been received, means for printing out mail pieces for respective addressees in an order corresponding to a predetermined delivery route.

37. A system for distributing mail in accordance with claim 36 and further comprising, at one of the distribution centers, means for printing together multiple mail pieces for a given addressee.
